(19) United States
(12) Patent Application Publication
(10) Pub. No.: US 2018/0126808 A1
(43) Pub. Date: May 10, 2018

(54) METHOD FOR DETERMINING CONCENTRIC MOUNTING OF A TIRE ON A WHEEL

(71) Applicant: Bridgestone Americas Tire Operations, LLC, Nashville, TN (US)

(72) Inventors: Todd A. BUXTON, Norton, OH (US); Jason R. MISUTKA, New Franklin, OH (US); Steven M. SAWYER, Akron, OH (US); Christopher SWARTZWELDER, Akron, OH (US); Guy J. WALENGA, Mt. Juliet, TN (US)

(21) Appl. No.: 15/564,374

(22) PCT Filed: Mar. 30, 2016
(86) PCT No.: PCT/US2016/024989

§ 371 Date: Oct. 4, 2017

Related U.S. Application Data
(60) Provisional application No. 62/144,005, filed on Apr. 7, 2015.

(51) Int. Cl. B60C 25/05

(52) U.S. Cl. CPC B60C 25/0554

(57) ABSTRACT

Method for determining concentric mounting of a tire on a wheel. In one embodiment, method for determining concentric mounting of a tire on a wheel comprises: providing a tire including at least one bead area, wherein at least one rim centering tolerance indicator is oriented in the at least one bead area, and wherein the at least one rim centering tolerance indicator extends circumferentially about the tire; mounting the tire on a wheel to form a tire-wheel assembly, the wheel includes a circular cross-section including a center point; rotatably mounting the tire-wheel assembly on a tire balancing machine; providing a light source adjacent to the tire-wheel assembly, the light source projects a projected reference point upon the at least one bead area; rotating the tire-wheel assembly; and observing the runout of the projected reference point relative to the at least one rim centering tolerance indicator.

### BACKGROUND

When mounting a tire upon a rim, it is important to ensure that the tire and rim are at least substantially concentric. That is, an accepted industry tolerance exists for a tire's placement on a rim. An eccentric tire and rim relationship, outside of the accepted industry tolerance, may lead to irregular wear and reduced tread life.

Some tires include substantially circumferential lines extending about the sidewall of the tire. These lines are referred to as a first rim line and a second rim line. The first rim line, if available, is typically used by tire manufacturers and engineers as a reference point for analyzing tire sections. The first rim line is sometimes concealed from view by the rim's flange when the tire is mounted on the rim. However, the first rim line, which is ordinarily positioned at least somewhat radially-outwardly from the rim's flange, may also be utilized as a point against which to measure offset between a rim and a tire, and thus identify whether the tire and rim relationship is within the specified tolerances. Because the first rim line is often positioned radially-outwardly from the rim's flange in the tire's sidewall by some distance, an individual is required to take multiple measurements between the first rim line and the rim, about various points on the circumference of the rim. Due the curvature of the rim, it is difficult to obtain an accurate measurement between the first rim line and the rim.

What is needed is a method for ensuring that a tire and rim are concentric using a tire having rim centering tolerance indicators that create multiple visual points of reference.

### SUMMARY

In one embodiment, a method for determining concentric mounting of a tire on a wheel is provided, the method comprising: providing a tire including at least one bead area, wherein at least one rim centering tolerance indicator is oriented in the at least one bead area, and wherein the at least one rim centering tolerance indicator extends circumferentially about the tire; mounting the tire on a wheel to form a tire-wheel assembly, wherein the wheel includes a circular cross-section including a center point; rotatably mounting the tire-wheel assembly on a tire balancing machine; providing a light source adjacent to the tire-wheel assembly, wherein the light source projects a projected reference point upon the at least one bead area; rotating the tire-wheel assembly; and observing the runout of the projected reference point relative to the at least one rim centering tolerance indicator.

In another embodiment, a method for determining concentric mounting of a tire on a wheel is provided, comprising: providing a tire including at least one bead area, wherein three rim centering tolerance indicators are oriented in the at least one bead area, wherein the three rim centering tolerance indicators extend circumferentially about the tire, wherein each of the three rim centering tolerance indicators are concentric to one another, and wherein each of the three rim centering tolerance indicators are separated by a radial distance of about 1.5 mm; mounting the tire on a wheel to form a tire-wheel assembly, wherein the wheel includes a circular cross-section including a center point; rotatably mounting the tire-wheel assembly on a tire balancing machine; providing a light source adjacent to the tire-wheel assembly, wherein the light source projects a projected reference point upon the at least one bead area; rotating the tire-wheel assembly; and observing the runout of the projected reference point relative to the three rim centering tolerance indicator.

In another embodiment, a method for determining concentric mounting of a tire on a wheel is provided, comprising: providing a tire including at least one bead area, wherein three rim centering tolerance indicators are oriented in the at least one bead area, wherein the three rim centering tolerance indicators extend circumferentially about the tire, wherein each of the three rim centering tolerance indicators are concentric to one another, and wherein each of the three rim centering tolerance indicators are separated by a radial distance of 1.5 mm; mounting the tire on a wheel to form a tire-wheel assembly, wherein the wheel includes a circular cross-section including a center point; rotatably mounting the tire-wheel assembly on a tire balancing machine; providing a light source adjacent to the tire-wheel assembly, wherein the light source projects a projected reference point upon the at least one bead area; rotating the tire-wheel assembly; and observing the runout of the projected reference point relative to the three rim centering tolerance indicator.

### BRIEF DESCRIPTION OF THE DRAWINGS

The accompanying figures, which are incorporated in and constitute a part of the specification, illustrate various example systems and apparatuses, and are used merely to illustrate various example embodiments. In the figures, like elements bear like reference numerals.

FIG. 1A illustrates an example embodiment of a tire 100 including at least one rim centering tolerance indicator 108.

FIG. 1B illustrates a partial view of an example embodiment of tire 100 including at least one rim centering tolerance indicator 108A, 108B, 108C.

FIG. 2A illustrates an example embodiment of a tire 200 including at least one rim centering tolerance indicator 208 mounted on a rim 210.

FIG. 2B illustrates a partial view of an example embodiment of tire 200 including at least one rim centering tolerance indicator 208A, 208B mounted on rim 210.

FIG. 3A illustrates an example embodiment of a tire 300 including at least one rim centering tolerance indicator 308 mounted on a rim 310.

FIG. 3B illustrates a partial view of an example embodiment of tire 300 including at least one rim centering tolerance indicator 308A, 308B mounted on rim 310.

FIG. 4A illustrates a partial view of an example embodiment of a tire sidewall 402 including at least one rim centering tolerance indicator 408A, 408B mounted on a rim 410.

FIG. 4B illustrates a partial view of an example embodiment of tire sidewall 402 including at least one rim centering tolerance indicator 408A, 408B mounted on rim 410.

FIG. 4C illustrates a partial view of an example embodiment of tire sidewall 402 including at least one rim centering tolerance indicator 408A, 408B mounted on rim 410.

FIG. 5 illustrates a partial view of an example embodiment of a tire sidewall 502 including at least one rim centering tolerance indicator 508A, 508B mounted on a rim 510.

FIG. 6 illustrates an example embodiment of a tire 600 mounted on a wheel, and mounted on a tire balancing machine 620.

### DETAILED DESCRIPTION

When a tire is mounted on a rim, the fitment between the tire and the rim may be such that the tire may actually mount on the rim without being within the industry accepted rim centering tolerance. That is, an industry standard tolerance for tire and rim alignment, herein referred to as a rim centering tolerance, exists to ensure that a tire is centered on a rim within an acceptable degree of error to avoid the negative effects of tire and rim eccentricity.

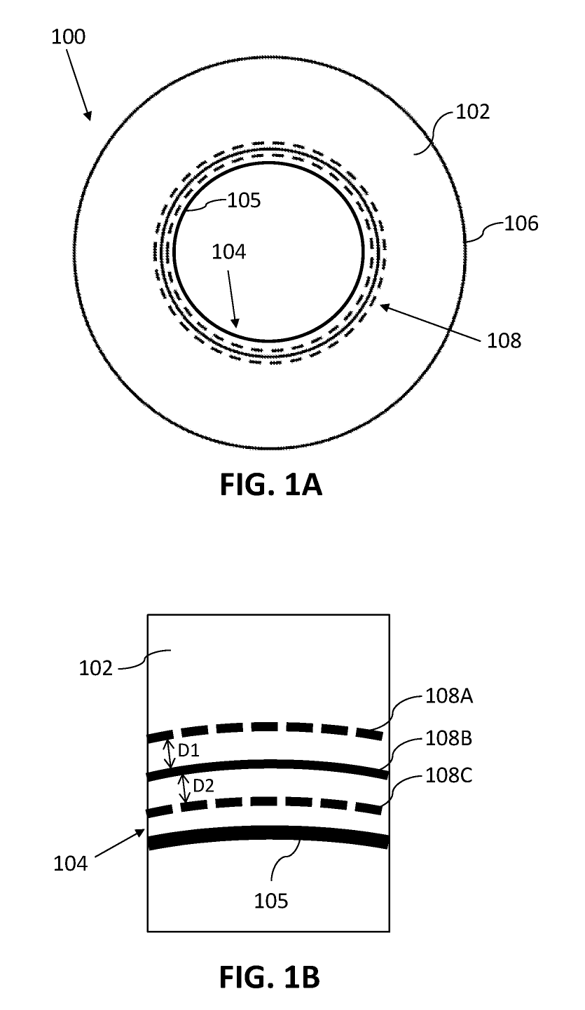

FIG. 1A illustrates a tire 100 including at least one rim centering tolerance indicator 108. Tire 100 includes at least one sidewall 102 and at least one bead area 104. Tire 100 may include a radially innermost portion 105. Tire 100 may include a tread portion 106. Tire 100 may include at least one rim centering tolerance indicator 108.

Tire 100 may comprise any of a variety of tires, including a pneumatic tire, a non-pneumatic tire, a passenger tire, a truck tire, a bus tire, an off-the-road tire, and an agricultural tire.

At least one sidewall 102 may comprise a portion of tire 100 extending between tread portion 106 and at least one bead area 104. In one embodiment, sidewall portion 102 does not include any portion of at least one bead area 104. In one embodiment, sidewall 102 may include all of at least one bead area 104.

At least one bead area 104 may comprise a portion of tire 100 configured to contact a flange of a wheel rim when tire 100 is mounted on a rim (not shown). Radially innermost portion 105 may contact a flange of a wheel rim when tire 100 is mounted on a rim (not shown). At least one bead area 104 may comprise a radially-inwardly portion of tire 100. In one embodiment, at least one bead area 104 comprises an upper bead area, which may be defined as a portion of bead area 104 that is oriented at and near the radially-outwardly extending edge of bead area 104. In one embodiment, the upper bead area extends to, but does not overlap, sidewall 102.

In one embodiment, tire 100 comprises at least one rim centering tolerance indicator 108. At least one rim centering tolerance indicator 108 may be oriented in at least one bead area 104. In one embodiment, no rim centering tolerance indicator 108 is oriented on sidewall 102. At least one rim centering tolerance indicator 108 may be oriented on a lower, radially inward, portion of sidewall 102. At least one rim centering tolerance indicator 108 may include a plurality of rim centering tolerance indicators 108. At least one rim centering tolerance indicator 108 may include at least two rim centering tolerance indicators 108. At least one rim centering tolerance indicator 108 may include at least three rim centering tolerance indicators 108.

At least one rim centering tolerance indicator 108 may comprise at least one of a substantially circumferential ring, and a reference mark. In one embodiment, as illustrated in FIG. 1, at least one rim centering tolerance indicator 108 comprises at least one ring extending about the circumference of at least one bead area 104. In another embodiment, at least one rim centering tolerance indicator 108 comprises at least one reference mark. In another embodiment, at least one rim centering tolerance indicator 108 comprises a combination of any number of substantially circumferential rings and reference marks. In another embodiment, at least one rim centering tolerance indicator 108 comprises a substantially solid circumferential ring. In another embodiment, at least one rim centering tolerance indicator 108 comprises a discontinuous circumferential ring. In another embodiment, as illustrated in FIG. 1, at least one rim centering tolerance indicator 108 comprises a combination of at least one substantially solid circumferential ring and at least one discontinuous circumferential ring. In one embodiment, at least one rim centering tolerance indicator 108 comprises a first rim line. In another embodiment, at least one rim centering tolerance indicator 108 comprises a first rim groove.

At least one rim centering tolerance indicator 108 may comprise any element configured to be visually detectable by an individual mounting tire 100 on a rim (not shown). In one embodiment, rim centering tolerance indicator 108 comprises a raised indicia extending from the surface of bead area 104. In another embodiment, rim centering tolerance indicator 108 comprises a recessed indicia extending into the surface of bead area 104. In another embodiment, rim centering tolerance indicator 108 comprises a combination of raised and recessed indicia. In one embodiment, rim centering tolerance indicator 108 comprises a colored indicia placed upon, formed into, or both, bead area 104. In one embodiment, tire 100 comprises a plurality of rim centering tolerance indicators 108, each of which may comprise differing or alternating colors, textures, raised portions, recessed portions, and the like. Rim centering indicator 108 may extend substantially circumferentially about tire 100. Rim centering indicator 108 may extend substantially radially on tire 100.

When tire 100 is mounted on a rim (not shown), at least one of rim centering tolerance indicators 108 may be aligned with or visible around a flange of the rim. In one embodiment, the flange of the rim (not shown) extends across bead area 104 from a radially-inwardly direction (the flange comprising an outer radius) and terminates at or near at least one of rim centering tolerance indicators 108. In one embodiment, aligning an outer radius of a rim flange (not shown) with at least one of rim centering tolerance indicators 108 may indicate to an individual mounting tire 100 onto a rim that tire 100 is substantially concentric with, or within rim centering tolerance with, the rim. In another embodiment, confirming visually that the radially-innermost rim centering indicator 108 that is exposed around the rim's flange, is visible completely about the circumference of a rim flange, (not shown) may indicate to an individual mounting tire 100 onto a rim that tire 100 is substantially concentric with, or within rim centering tolerances with, the rim. In another embodiment, confirming visually that any rim centering indicator 108 that is exposed around the rim's flange, is visible completely about the circumference of a rim flange, (not shown) may indicate to an individual mounting tire 100 onto a rim that tire 100 is substantially concentric with, or within rim centering tolerances with, the rim.

In one embodiment, any of various rims upon which tire 100 may be mounted comprise any of various geometries and sizes of rim flanges (not shown). A rim flange on one rim may extend a radially greater or lesser distance than a comparable rim flange. As such, tire 100 may comprise a plurality of rim centering tolerance indicators 108 to take into account various rim flange geometries and sizes. In one embodiment, tire 100 comprises a plurality of rim centering tolerance indicators 108, at least one of which may be aligned with or visible around the outer radius of any of a variety of rim flanges (not shown) during mounting of tire 100 on a rim. Alignment of at least one rim centering tolerance indicator 108 with an outer radius of a rim flange may indicate to an individual mounting tire 100 onto a rim that tire 100 is substantially concentric with the rim. In one embodiment, a rim flange may comprise an outer radius greater than a radius of at least one rim centering tolerance indicator 108, and as such may conceal that particular rim centering tolerance indicator 108 from view. However, a rim flange may comprise an outer radius less than a radius of another rim centering tolerance indicator 108, which can be used to visually confirm concentricity of tire 100 and the rim. In one embodiment, the radius of a first rim centering tolerance indicator 108 and the radius of a second rim centering tolerance indicator 108 differ by about 1.5 mm. In one embodiment, the radius of a first rim centering tolerance indicator 108 and the radius of a second rim centering tolerance indicator 108 differ by 1.5 mm. The radius of a first rim centering tolerance indicator 108 and the radius of a second rim centering tolerance indicator 108 may differ by about 1.6 mm. The radius of a first rim centering tolerance indicator 108 and the radius of a second rim centering tolerance indicator 108 may differ by 1.6 mm.

FIG. 1B illustrates a partial view of tire 100. Tire 100 may include at least one rim centering tolerance indicator 108A, 108B, 108C. At least one rim centering tolerance indicator 108A and 108B may be radially offset from one another by a distance D1. At least one rim centering tolerance indicator 108B and 108C may be radially offset from one another by a distance D2. At least one of distance D1 and distance D2 may be about 1.5 mm. At least one of distance D1 and distance D2 may be 1.5 mm. At least one of distance D1 and distance D2 may be about 1.6 mm. At least one of distance D1 and distance D2 may be 1.6 mm. At least one of distance D1 and distance D2 may be less than about 1.5 mm. At least one of distance D1 and distance D2 may be less than 1.5 mm. At least one of distance D1 and distance D2 may be greater than about 1.5 mm. At least one of distance D1 and distance D2 may be greater than 1.5 mm.

Rim centering tolerance indicator 108A may be a radially outwardly-most rim centering tolerance indicator. Rim centering tolerance indicator 108C may be a radially inwardly-most rim centering tolerance indicator. Rim centering tolerance indicator 108B may be a radially-central rim centering tolerance indicator.

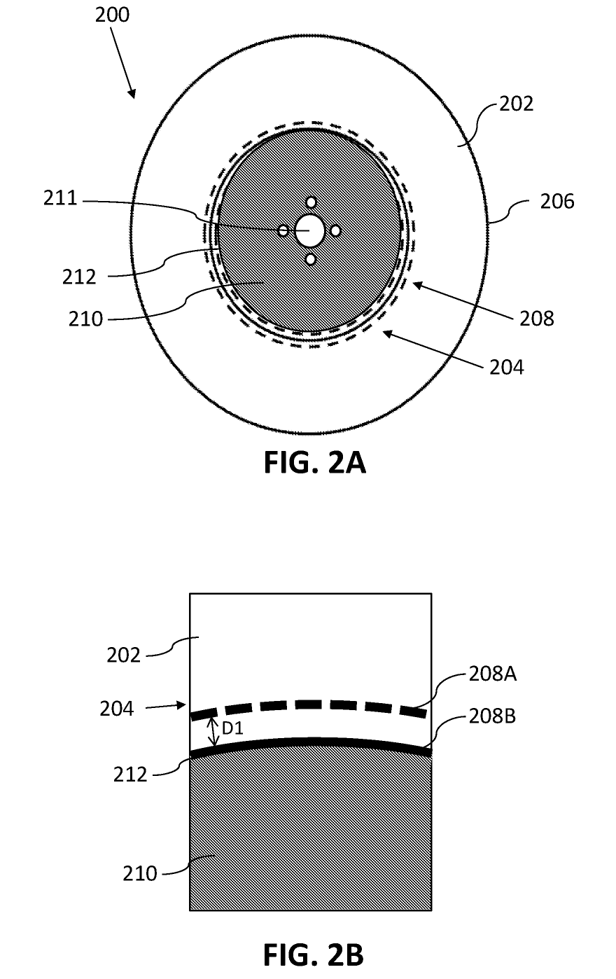

FIG. 2A illustrates a tire 200 including at least one rim centering tolerance indicator 208. Tire 200 includes at least one sidewall 202 and at least one bead area 204. Tire 200 may include a tread portion 206. Tire 200 may include at least one rim centering tolerance indicator 208.

Tire 200 may be mounted on a wheel 210, forming a tire-wheel assembly. Wheel 210 may be a vehicle wheel. Wheel 210 and the tire-wheel assembly may be a wheel for application to an of a variety of vehicles, including: a passenger vehicle, a motorcycle, an all-terrain vehicle, an agricultural vehicle, an off-the-road vehicle, a tractor-trailer, an airplane, a trailer, a wagon, and the like.

Wheel 210 may include a center point 211. Wheel 210 may have a substantially circular cross-section, and center point 211 may be defined as the center of the circular cross-section. Wheel 210 may rotate about an axis that passes through center point 211. Center point 211 may be the axis of rotation of wheel 210 as it rotates.

Wheel 210 may include a rim flange 212. Rim flange 212 may be substantially circular in cross-section, having a center point at center point 211.

As illustrated in FIGS. 2A and 2B, tire 200 may be mounted on wheel 210 in a non-concentric orientation, such that center point 211 is not the same as the center point of tire 200 (not shown).

FIG. 2B illustrates a partial view of tire 200 mounted on wheel 210. Tire 200 may include at least one rim centering tolerance indicator 208A, 208B. At least one rim centering tolerance indicator 208A and 208B may be separated by a radial distance D1. In one embodiment, rim flange 212 at a first point of tire 200 may extend to rim centering tolerance indicator 208B, while rim flange 212 at a second point of tire 200 may extend to a different rim centering tolerance indicator (not shown). Such differences between the extent of rim flange 212 relative to rim centering tolerance indicators 208A, 208B at various points on tire 200 may be indicative of a lack of concentricity between tire 200 and wheel 210.

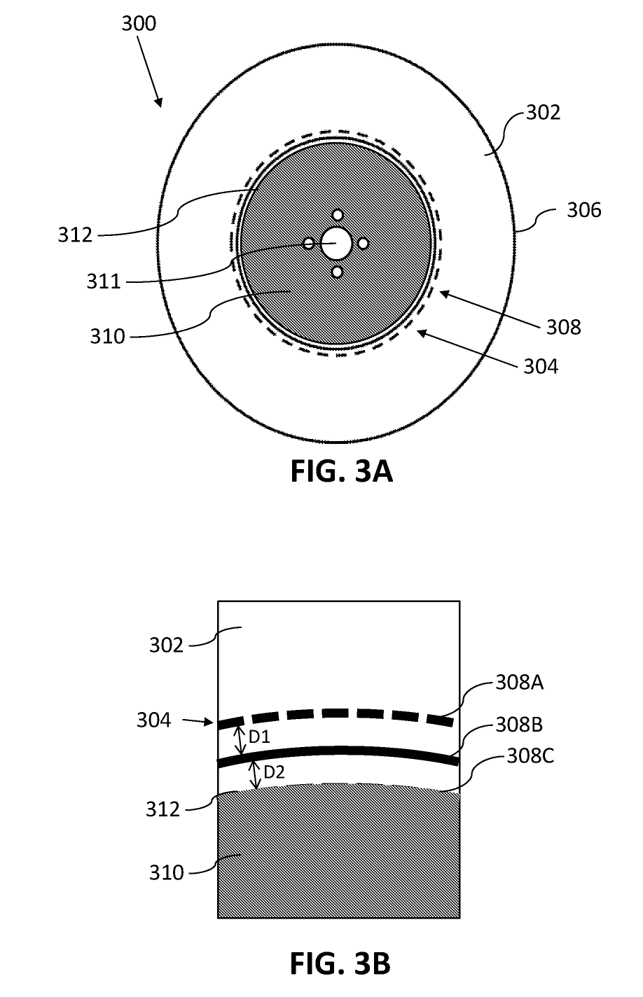

FIG. 3A illustrates a tire 300 including at least one rim centering tolerance indicator 308. Tire 300 includes at least one sidewall 302 and at least one bead area 304. Tire 300 may include a tread portion 306. Tire 300 may include at least one rim centering tolerance indicator 308.

Tire 300 may be mounted on a wheel 310, forming a tire-wheel assembly. Wheel 310 may include a center point 311. Wheel 310 may include a rim flange 312.

As illustrated in FIGS. 3A and 3B, tire 300 may be mounted on wheel 310 in a concentric orientation, such that center point 311 is the same as the center point of tire 300 (not shown).

FIG. 3B illustrates a partial view of tire 300 mounted on wheel 310. Tire 300 may include at least one rim centering tolerance indicator 308A, 308B, 308C. At least one rim centering tolerance indicator 308A and 308B may be separated by a radial distance D1. At least one rim centering tolerance indicator 308B and 308C may be separated by a radial distance D2. In one embodiment, rim flange 312 at a first point and a second point (e.g., the first and second points being on substantially opposite sides of the tire-wheel assembly, and separated by about 180 degrees) of tire 300 may extend to rim centering tolerance indicator 308C. The first and second points being on substantially opposite sides of the tire-wheel assembly, and separated by 180 degrees. Such consistency between the extent of rim flange 312 relative to rim centering tolerance indicator 308C may be indicative of concentricity between tire 300 and wheel 310.

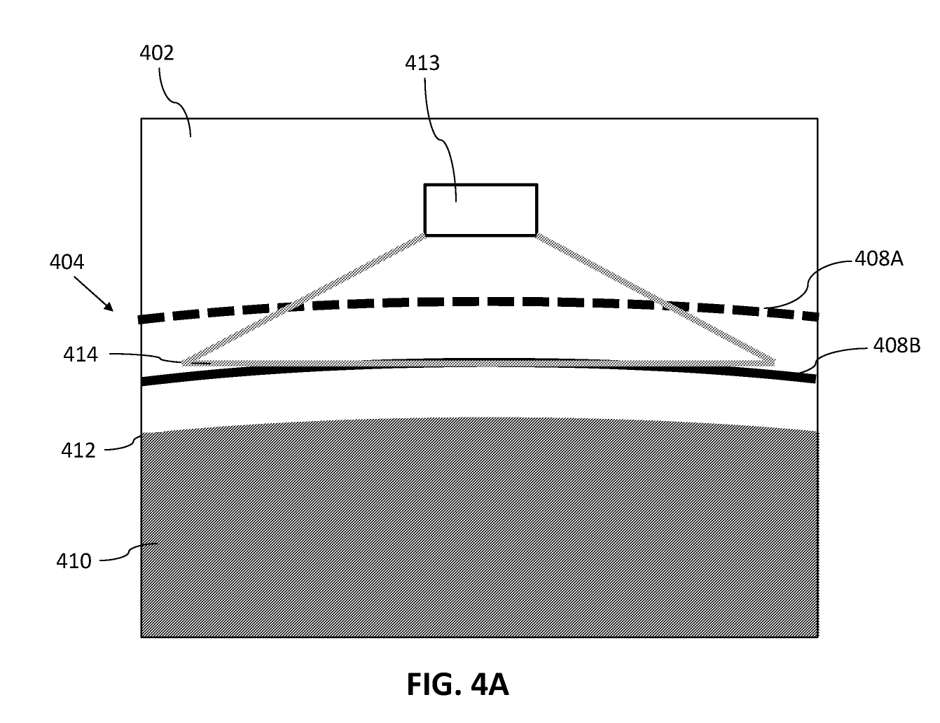

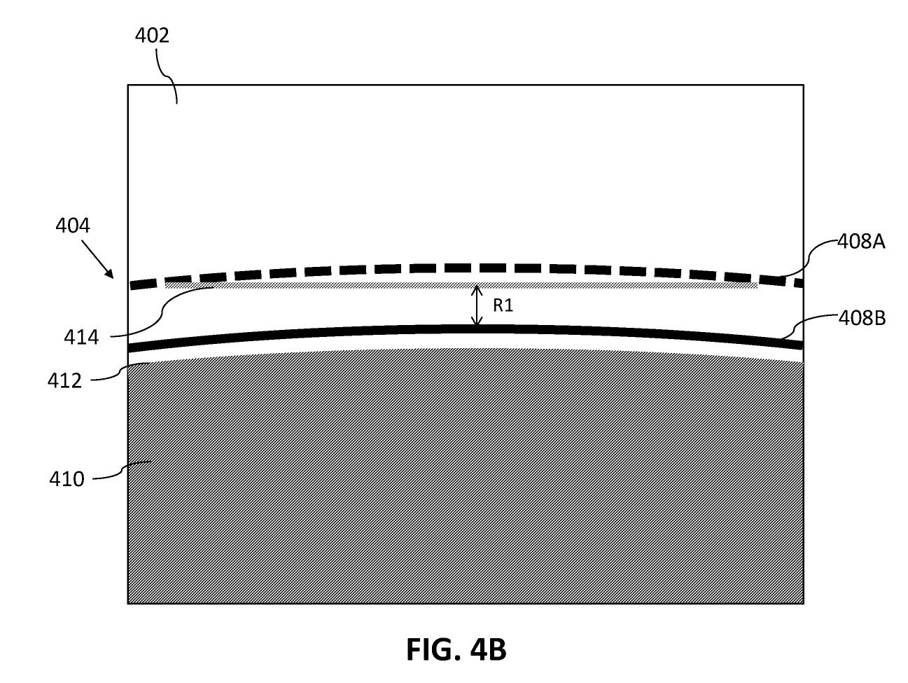

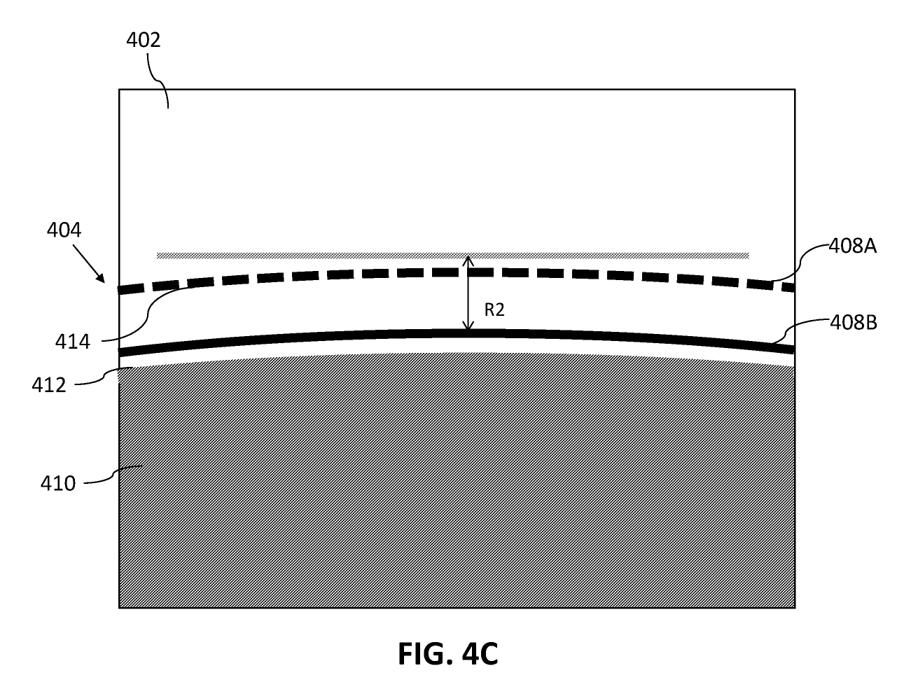

FIG. 4A illustrates a tire sidewall 402 including at least one rim centering tolerance indicator 408A, 408B. Tire sidewall 402 may include, or be adjacent to, at least one bead area 404.

Tire 400 may be mounted on a wheel 410, forming a tire-wheel assembly. Wheel 410 may include a center point (not shown). Wheel 410 may include a rim flange 412.

A light source 413 may be provided relative to the tire-wheel assembly to project a projected reference point 414. Projected reference point 414 may be projected upon a surface of the tire-wheel assembly. Projected reference point 414 may be projected upon a surface of tire sidewall 402 or bead area 404.

Light source 413 may be any of a variety of light sources capable of projecting a light upon a surface, including for example: a laser, an incandescent light, a fluorescent light, a high-intensity discharge light, a light emitting diode light, and the like. Light source 413 may include any of a variety of lenses, masks, filters, and the like configured for focusing the light to create a readily discernable projected reference point 414 upon a surface. Projected reference point 414 may include a laser beam.

Projected reference point 414 may comprise any of a variety of shapes, including for example: a line, an arc, a dotted line, hash marks, a pattern of dots, a pattern of shapes, a dot, a shape, a ring, a crosshair, a bullseye, and the like. Where projected reference point 414 is a line, the line may be substantially tangent to a circumference of tire sidewall 402. Where projected reference point 414 is an arc, the arc may be substantially parallel to at least one rim centering tolerance indicator 408A, 408B. Stated differently, where projected reference point 414 is an arc, the arc may extend with a similar radius of curvature to at least one rim centering tolerance indicator 408A, 408B.

In practice, a user may mount tire having tire sidewall 402 and bead area 404 on wheel 414, creating a tire-wheel assembly. The tire-wheel assembly may be operatively connected to light source 413. Light source 413 may be oriented adjacent the tire-wheel assembly. Light source 413 may project projected reference point 414 onto at least one of tire sidewall 402 and bead area 404. A user may visually observe projected reference point 414's position on at least one of tire sidewall 402 and bead area 404 relative to at least one rim centering tolerance indicator 408A, 408B. The user may rotate light source 413 and tire-wheel assembly relative to one another about an axis extending through the center point of wheel 410 (e.g., via rotating light source 413 relative to tire-wheel assembly, or via rotating tire-wheel assembly relative to light source 413). As a result, projected reference point 414 may be projected, continuously, or intermittently, about a plurality of points about at least a portion of the circumference of at least one of sidewall 402 and bead area 404.

Monitoring the radial displacement of a point on a tire while it is rotating is referred to as measuring its runout. In one embodiment, one may visually monitor the runout of projected reference point 414 during rotation of the tire-wheel assembly.

In one embodiment, a tire may be mounted on wheel 410, forming a tire-wheel assembly. After mounting, but before balancing of the tire-wheel assembly, the tire-wheel assembly may be mounted on a tire machine (not shown). Light source 413 may be oriented upon the tire machine in a stationary position and configured to project projected reference point 414 onto a surface of at least one of sidewall 402 and bead area 404. The tire-wheel assembly may be rotated and the runout of projected reference point 414 may be observed. If the runout of projected reference point 414 is within acceptable tolerances of concentricity, the tire-wheel assembly may be balanced. If the runout of projected reference point 414 is not within acceptable tolerances of concentricity, the tire-wheel assembly may be dismounted, and the tire may be removed from wheel 410 to be remounted to achieve acceptable tolerances of concentricity.

In one embodiment, the tire-wheel assembly is rotated at least about 90 degrees. In another embodiment, the tire-wheel assembly is rotated at least about 180 degrees. In another embodiment, the tire-wheel assembly is rotated at least about 270 degrees. In another embodiment, the tire-wheel assembly is rotated about 360 degrees. In another embodiment, the tire-wheel assembly is rotated about 360 degrees or less.

In one embodiment, the tire-wheel assembly is rotated at least 90 degrees. In another embodiment, the tire-wheel assembly is rotated at least 180 degrees. In another embodiment, the tire-wheel assembly is rotated at least 270 degrees. In another embodiment, the tire-wheel assembly is rotated 360 degrees. In another embodiment, the tire-wheel assembly is rotated 360 degrees or less.

In one embodiment, projected reference point 414 may be oriented initially upon rim centering tolerance indicator 408B. The tire-wheel assembly may be rotated and the runout of projected reference point 414 may be observed.

As illustrated in FIG. 4B, in one embodiment, where projected reference point 414 does not extend radially outwardly of rim centering tolerance indicator 408A, or radially inwardly of rim centering tolerance indicator 408C, during rotation of the tire-wheel assembly, then the tire-wheel assembly is within acceptable tolerances of concentricity. Projected reference point 414 may have a maximum runout of runout R1.

As illustrated in FIG. 4C, in one embodiment, where projected reference point 414 extends radially outwardly of rim centering tolerance indicator 408A, or radially inwardly of rim centering tolerance indicator 408C, during rotation of the tire-wheel assembly, then the tire-wheel assembly is not within acceptable tolerances of concentricity. Projected reference point 414 may have a maximum runout of runout R2.

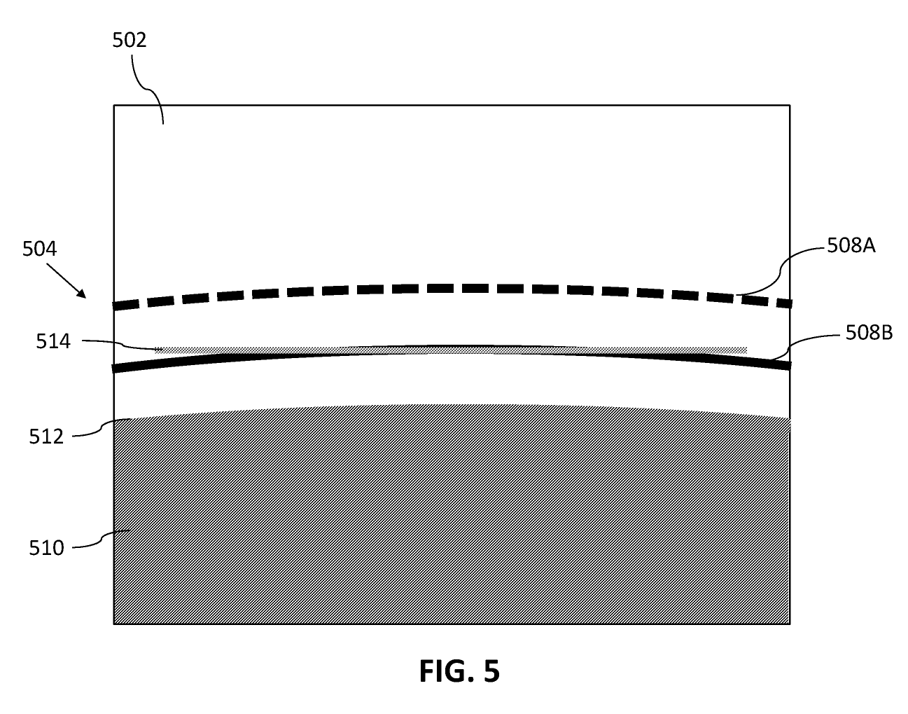

FIG. 5 illustrates a tire sidewall 502 including at least one rim centering tolerance indicator 508A, 508B. Tire sidewall 502 includes, or is adjacent to, at least one bead area 504.

Tire 500 may be mounted on a wheel 510, forming a tire-wheel assembly. Wheel 510 may include a center point (not shown). Wheel 510 may include a rim flange 512.

A light source (not shown) may be provided relative to the tire-wheel assembly to project a projected reference point 514. Projected reference point 514 may be projected upon a surface of the tire-wheel assembly. Projected reference point 514 may be projected upon a surface of at least one of tire sidewall 502 and bead area 504.

In one embodiment, projected reference point 514 may be caused to fall upon rim centering tolerance indicator 508B. The tire-wheel assembly may be rotated and projected reference point 514 may remain in contact with rim centering tolerance indicator 508B, which may indicate concentricity of the tire relative to wheel 510.

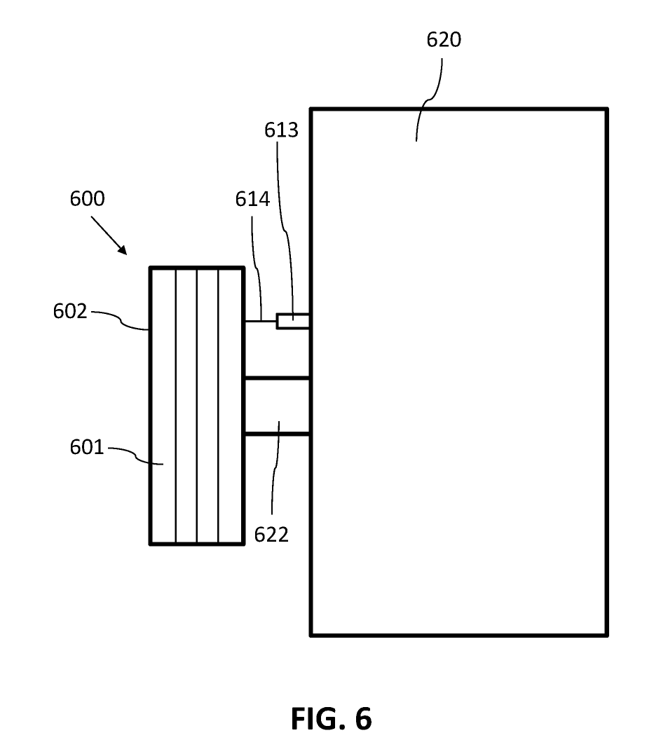

FIG. 6 illustrates a tire 600 mounted on a wheel to from a tire-wheel assembly 601, which is mounted on a tire balancing machine 620. Tire 600 may include at least one sidewall 602.

A light source 613 may be oriented upon tire balancing machine 620. Light source 613 may project a projected reference point 614 onto at least one of sidewall 602 and a bead area (not shown). Projected reference point 614 may be adjusted radially on at least one of sidewall 602 and a bead area (not shown) to be projected upon a specific rim centering tolerance indicator, including for example rim centering tolerance indicator 508B illustrated in FIG. 5.

Tire-wheel assembly 601 may be operatively connected to tire balancing machine 620 via a shaft 622. Shaft 622 may rotate relative to tire balancing machine 620, thus causing tire-wheel assembly 601 to rotate relative to tire balancing machine 620. The axis of rotation of shaft 622 may be collinear with a center point of the wheel of tire-wheel assembly.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A method for determining concentric mounting of a tire on a wheel, comprising:
providing a tire including at least one bead area, wherein at least one rim centering tolerance indicator is oriented in the at least one bead area, and wherein the at least one rim centering tolerance indicator extends circumferentially about the tire;
mounting the tire on a wheel to form a tire-wheel assembly, wherein the wheel includes a circular cross-section including a center point;
rotatably mounting the tire-wheel assembly on a tire balancing machine;
providing a light source adjacent to the tire-wheel assembly, wherein the light source projects a projected reference point upon the at least one bead area;
rotating the tire-wheel assembly; and
observing the runout of the projected reference point relative to the at least one rim centering tolerance indicator.

2. The method of claim 1, wherein the light source is a laser.

3. The method of claim 1, wherein the projected reference point is a laser beam.

4. The method of claim 1, wherein the projected reference point is a line that is tangent to the at least one rim centering tolerance indicator.

5. The method of claim 1, wherein the at least one rim centering tolerance indicator includes three rim centering tolerance indicators, each concentric to the others, and each separated by a radial distance of 1.5 mm.

6. The method of claim 5, further comprising observing the runout of the projected reference point relative to the three rim centering tolerance indicators and observing whether the projected reference point extended radially outwardly of a radially outwardly-most rim centering tolerance indicator, and observing whether the projected reference point extended radially inwardly of a radially inwardly-most rim centering tolerance indicator.

7. The method of claim 5, wherein the projected reference point is projected upon a radially-central rim centering tolerance indicator before the tire-wheel assembly is rotated.

8. The method of claim 1, wherein the tire-wheel assembly is rotated at least 180 degrees.

9. The method of claim 1, wherein the tire-wheel assembly is rotated 360 degrees.

10. The method of claim 1, wherein the tire-wheel assembly is rotated about an axis that is collinear with the center point of the wheel.

11. A method for determining concentric mounting of a tire on a wheel, comprising:
providing a tire including at least one bead area, wherein three rim centering tolerance indicators are oriented in the at least one bead area, wherein the three rim centering tolerance indicators extend circumferentially about the tire, wherein each of the three rim centering tolerance indicators are concentric to one another, and wherein each of the three rim centering tolerance indicators are separated by a radial distance of 1.5 mm;
mounting the tire on a wheel to form a tire-wheel assembly, wherein the wheel includes a circular cross-section including a center point;
rotatably mounting the tire-wheel assembly on a tire balancing machine;
providing a light source adjacent to the tire-wheel assembly, wherein the light source projects a projected reference point upon the at least one bead area;
rotating the tire-wheel assembly; and
observing the runout of the projected reference point relative to the three rim centering tolerance indicators.

12. The method of claim 11, wherein the light source is a laser.

13. The method of claim 11, wherein the projected reference point is a laser beam.

14. The method of claim 11, wherein the projected reference point is a line that is tangent to the three rim centering tolerance indicators.

15. The method of claim 11, further comprising observing whether the projected reference point extended radially outwardly of a radially outwardly-most rim centering tolerance indicator, and observing whether the projected reference point extended radially inwardly of a radially inwardly-most rim centering tolerance indicator.

16. The method of claim 11, wherein the projected reference point is projected upon a radially-central rim centering tolerance indicator before the tire-wheel assembly is rotated.

17. The method of claim 11, wherein the tire-wheel assembly is rotated at least 180 degrees.

18. The method of claim 11, wherein the tire-wheel assembly is rotated 360 degrees.

19. The method of claim 11, wherein the tire-wheel assembly is rotated about an axis that is collinear with the center point of the wheel.
